(19) United States
(12) Patent Application Publication
(10) Pub. No.: US 2018/0227652 A1
(43) Pub. Date: Aug. 9, 2018

(54) MOUNTING OF ITEMS ON CEILING OR WALL PANELS

(71) Applicant: Monitor Audio Limited, Rayleigh (GB)

(72) Inventors: Rianna Francesca Foster, Hemel Hempstead (GB); Charles Edward Minett, London (GB); Dean Stephen Hartley, Wakefield (GB); Matthew Alexander Robert Sharp, Ingatestone (GB)

(21) Appl. No.: 15/883,409

(22) Filed: Jan. 30, 2018

(30) Foreign Application Priority Data
Feb. 3, 2017 (GB) 1701839.1

(51) Int. Cl. H04R 1/02

(52) U.S. Cl. CPC H04R 1/025; H04R 2201/021; H04R 1/026

(57) ABSTRACT

A bracket for use in mounting an item (such as a loudspeaker) in an aperture in a wall or ceiling panel. The bracket is foldable between a folded condition, in which it can be inserted into the aperture from one side, and an open condition in which, in use, the bracket engages the panel so as to prevent removal of the bracket. When in its open condition, the bracket has receiving structure for receiving said item.

### FIELD

This disclosure relates to a bracket for use in mounting an item in an aperture in a wall or ceiling panel, to a mounting bracket for mounting a loudspeaker in an aperture on a wall or ceiling panel and to a loudspeaker and mounting bracket for mounting the loudspeaker in an aperture in a wall or ceiling panel.

### BACKGROUND

Conventionally, a ceiling or wall loudspeaker is mounted above or, as the case may be, behind a circular aperture cut in a ceiling or wall panel, which is typically of plasterboard. In some cases, the speaker is securely supported in position by being attached to a pre-construction bracket which has been attached to supports (such as joists) before the ceiling or wall is assembled. However, it is not possible to install such a bracket after the assembly of the ceiling or wall.

Some loudspeakers are adapted to being installed in a ceiling or wall by being clamped to the plasterboard panel. This avoids the need for a pre-construction bracket, but the clamping assembly of the speaker is typically relatively complicated, having a number of separate moving parts, such as “dog-leg” clamping members which need to be extended behind the plasterboard panel after the speaker has been inserted and then drawn down onto the panel to clamp the latter between the clamping members and, for example a flange that bears against the front of the panel. As well as increasing the size of the speaker and being complicated, this type of arrangement can sometimes fail to operate properly, for example if the clamping members do not adequately extend.

U.S. Pat. No. 7,540,460 shows a mounting bracket arrangement which is formed from two separate halves, each of which is small enough to be inserted through a panel hole. However, once inserted, the two halves need to be attached to nearby studs or joists and to that end have a relatively complicated arrangement of sliders which need to be attached to the studs or joists using fasteners. Since the joists or studs are concealed behind the panel, the correct positioning of the sliders and manipulation of the fasteners may prove to be difficult.

### SUMMARY

Brackets for use in mounting an item in an aperture in a wall or a ceiling panel are disclosed. In some examples, the bracket is foldable between a folded condition, in which it can be inserted into the aperture from one side, and an open condition in which, in use, the bracket engages the panel so as to prevent removal of the bracket. When in its open condition, the bracket has a receiving arrangement for receiving said item.

### BRIEF DESCRIPTION OF THE DRAWINGS

FIG. 1 is a view of the underside of an embodiment of a bracket in accordance with the present disclosure, the bracket being for use in mounting a loudspeaker in an aperture in a ceiling panel;

FIG. 2 is a plan view of the bracket, thus showing the bracket from the opposite side from that shown in FIG. 1;

FIG. 3 is a sectional view along the line A-A of FIG. 2;

FIG. 4 is a sectional view of the bracket taken along the line B-B of FIG. 2;

FIG. 5 is a side elevation view of the bracket when viewed from the same direction as the direction of FIG. 4;

FIG. 6 is a more detailed view of the area VI of FIG. 5;

FIG. 7 is a side elevation view of the bracket when viewed from the same direction as FIG. 3;

FIG. 8 illustrates how the bracket can be folded;

FIG. 9 shows how the folded bracket can fit through an aperture cut into a ceiling panel;

FIG. 10 is a plan view showing the bracket in place on a ceiling tile with a loudspeaker mounted on the bracket;

FIG. 11 is a sectional view of the loudspeaker and bracket, taken along the line C-C of FIG. 10;

FIG. 12 is a side elevation view of the loudspeaker and bracket, with the ceiling panel omitted;

FIG. 13 is a side elevation view from the opposite side of the bracket and loudspeaker, this time showing the ceiling tile in place; and

FIG. 14 is an isometric view of the loudspeaker, bracket and ceiling panel.

### DESCRIPTION

According to a first aspect of the disclosure, there is provided a bracket for use in mounting an item in an aperture in a wall or ceiling panel, wherein the bracket is foldable between a folded condition, in which it can be inserted into the aperture from one side and an open condition in which, in use, the bracket engages the panel so as to prevent removal of the bracket, the bracket, when in its open condition, having receiving structure for receiving said item.

Thus the bracket as a whole is, in effect, collapsible, so that it can be placed behind a pre-existing ceiling or wall panel by being passed through the aperture created in the panel to accommodate the item. The bracket can be of a simple construction which avoids the need to provide special formations, such as latches, sliders or dog-leg fixings on the item.

In some examples, the bracket includes an abutment which, in use, engages the face of the panel opposite said side, to enable the bracket to be secured to the panel.

If the panel is a horizontal ceiling panel, for example, the weight of the bracket and item will be transmitted to the panel through the abutment. The abutment, and hence the bracket, may be secured to the panel by screws or bolts passing through the panel and through corresponding passages in the abutment.

In some examples, the abutment comprises a flange.

In some examples, the receiving structure comprises an opening in the bracket, when in its open condition, the opening being surrounded by the flange.

In some examples, the flange comprises an annular flange.

In some examples, the foldability of the bracket is achieved by at least one hinge in the bracket.

In some examples, the hinge is one of two such hinges which are substantially coaxial and are on opposite sides of the receiving structure.

The bracket may thus comprise two halves hinged together to allow the bracket to be folded up, and then opened once inserted into the aperture in the panel. Such a construction facilitates fabrication of the brackets and so only needs to hinge about a single axis in order to be folded.

In some examples, each hinge is a living hinge.

This further simplifies the construction of the bracket, especially if the bracket is of a thermoplastics material, since the hinge may be formed in the process of moulding the bracket.

In some examples, the bracket includes a boss for extending from the flange into said aperture in the panel, to locate the bracket relative to the panel, the boss surrounding the aperture in the bracket, when the latter is in its open condition.

In some examples, the boss comprises a cylindrical wall or lip.

In some examples, the boss is surrounded by the flange, when the bracket is in its open condition.

In some examples, the boss is integrally formed with the flange.

In the case of a bracket made of a thermoplastics material, the bracket may, for example, be created by a process of injection moulding, using a two-part mould.

In some examples, the boss includes formations from which, in use, locating structure may project into the portion of the panel that defines the aperture therein, to retain the bracket in position on the panel.

In some examples, the formations comprise holes for accommodating locating structure in the form of pins, which, in the course of installing the bracket, are pushed through the holes and into the panel.

In some examples, the flange of the bracket includes passages for fixing screws so that such screws, having passed through corresponding openings in the item, can pass into the passages to clamp the panel between the bracket and the item.

In some examples, the bracket includes angular location structure for angularly locating the item relative to the bracket.

This enables the installer to insert the item into the opening with the screw holes of the item aligned with the passages in the bracket, despite the fact that those passages are on the opposite side of the panel and would thus not be visible to the installer.

The angular location structure comprises the opening in the bracket, the opening being of a non-circularly symmetric shape which corresponds to a correspondingly shaped portion of the item inserted into the opening, so as to prevent the item being inserted unless in a predetermined angular position relative to the bracket.

For example, the angular location structure may comprise a male member or a female receptor on the receiving structure of the bracket which cooperates with a complementary formation on the item. For example, the formations may comprise a female receptor in the faun of a recess or slot in the boss which, in use, cooperates with a radial protuberance (or pip) on the item to prevent the item from being inserted fully into the opening unless in the correct angular position.

In some examples, the bracket is for use in mounting an item comprising a loudspeaker.

According to a second aspect of the present disclosure, there is provided a mounting bracket for mounting a loudspeaker in an aperture in a wall or ceiling panel, the bracket comprising two halves which are hingedly joined together to enable the bracket to be opened from a collapsed condition, in which it can be passed through said aperture, into an open condition in which the bracket engages the panel.

The disclosure also lies in a loudspeaker and a bracket as aforesaid.

In some examples, the loudspeaker has a protuberance which cooperates with a female receptor in the bracket to ensure correct angular positioning of the loudspeaker relative to the bracket.

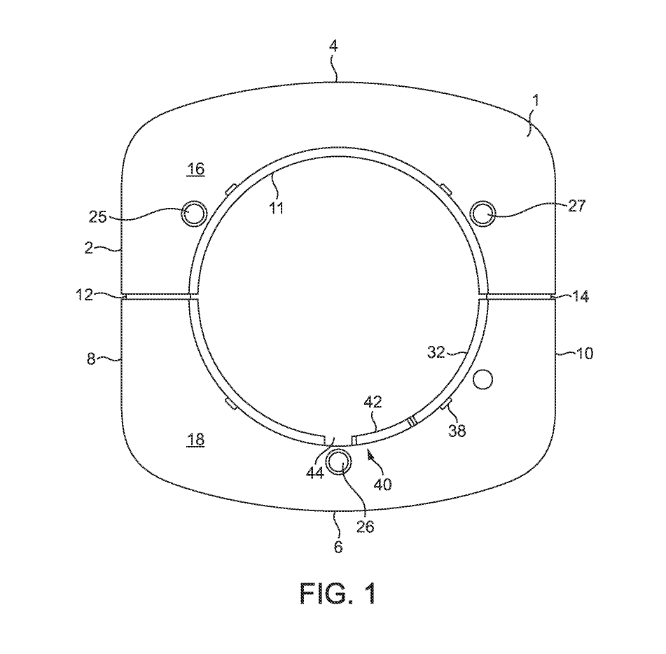

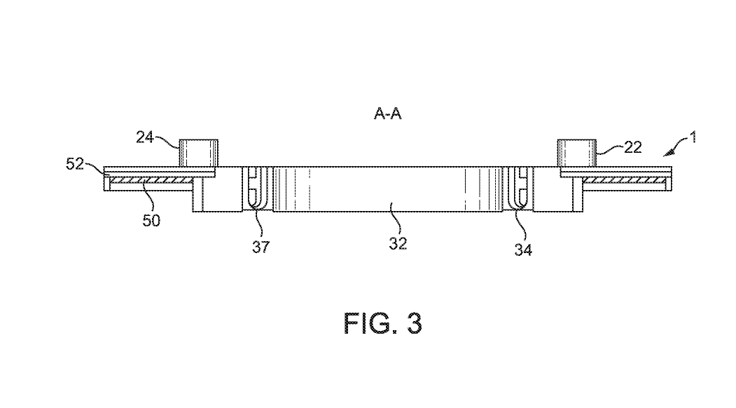

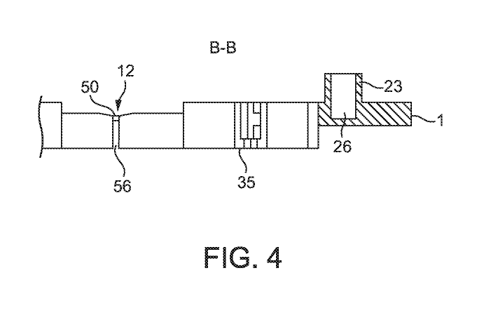

With reference to FIGS. 1-5, a loudspeaker bracket in accordance with the present disclosure comprises a flange 1 having an outer periphery 2 which is generally square shaped with rounded corners, a pair of opposed bulging sides 4 and 6 and a pair of straight sides 8 and 10.

The bracket is formed as a one piece moulding of a suitable thermoplastics material, for example, polypropylene, which is provided with a pair of opposed living hinges 12 and 14. The inner periphery of the flange defines an opening in the form of a circular aperture 11.

Each of the living hinges 12 and 14 is constituted by a web of the material of the bracket which is sufficiently thin to have the required flexibility for the hinge. It can be seen from FIG. 1 that the hinges 12 and 14 are coaxial and accordingly define a common hinge axis for the two halves 16 and 18 of the bracket.

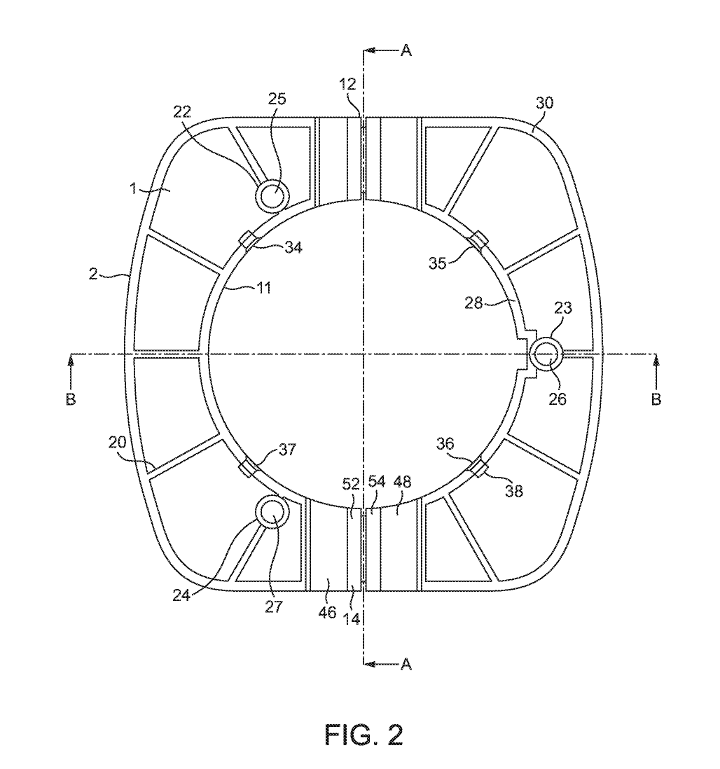

The upward facing surface of the flange 1 (i.e., that shown in FIG. 2) is provided with strengthening ribs, such as rib 20, which extend radially outwards from the aperture 11 to the outer periphery 2. Three hollow cylindrical projections 22-24 extend upwardly from the upper face of the flange 1 and define three corresponding passages respectively referenced 25-27, each of which is lined with a respective metal insert, in this example a screw threaded metal bushing, so that the passages can receive fixing screws for holding the bracket in place and clamping the bracket and loudspeaker together as described below.

The metal inserts enable the brackets to be removed and re-used as they can receive screws multiple times.

The inner periphery of the upper face of the flange 1 includes a generally circular projection 28, the top of which is substantially co-planar with the radial ribs 20 and an outer peripheral rib 30 around the edge of the flange. The circular rib 28 also constitutes the top of a cylindrical wall 32 which surrounds the aperture 11 and projects perpendicularly downwards from the underside of the flange 1. In use, the wall 32 acts as a boss that locates the bracket against the aperture in the ceiling panel.

The wall 32 is formed with four equi-angularly positioned radial, U-shaped openings 34-37, each of which is in register with a respective small U-shaped recess in the flange 1 (such as the recess 38). The recesses enable the bracket to be formed using a relatively simple construction of mould, without any undercuts. Each of the openings 34-37 is also counter-sunk at its radial inner end so that it can accommodate the head of a respective fixing pin.

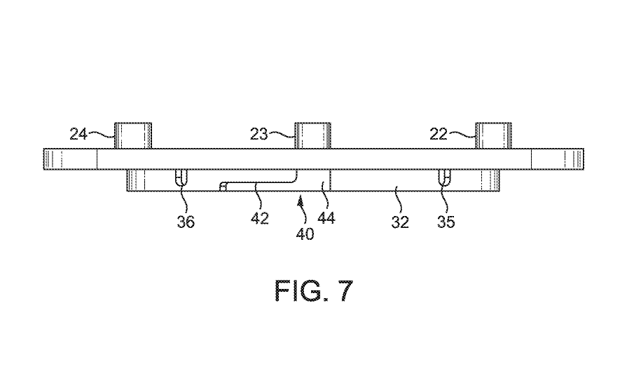

As can be seen from FIGS. 1 and 7, the lower edge of the wall 32 includes a generally L-shaped cutout, generally referenced 40, that defines a circumferential rail 42 that leads to an axial slot 44 substantially in alignment with the projection 23 and passage 26. The cutout 40 acts as a female receptor which cooperates with a protuberance or a pip on the loudspeaker to ensure that the loudspeaker can only be fully inserted into the bracket in one angular position relative to the bracket, in which position the protuberance can pass along the axial slot 44.

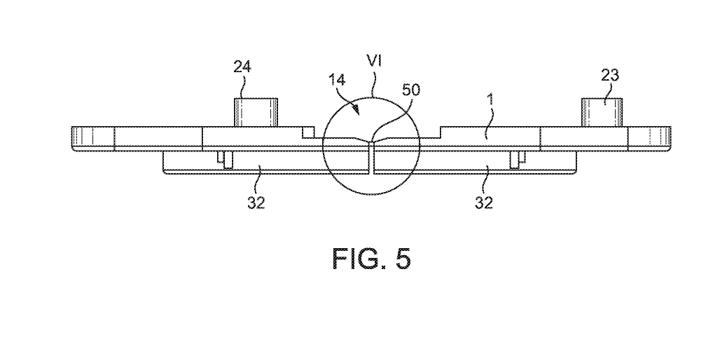

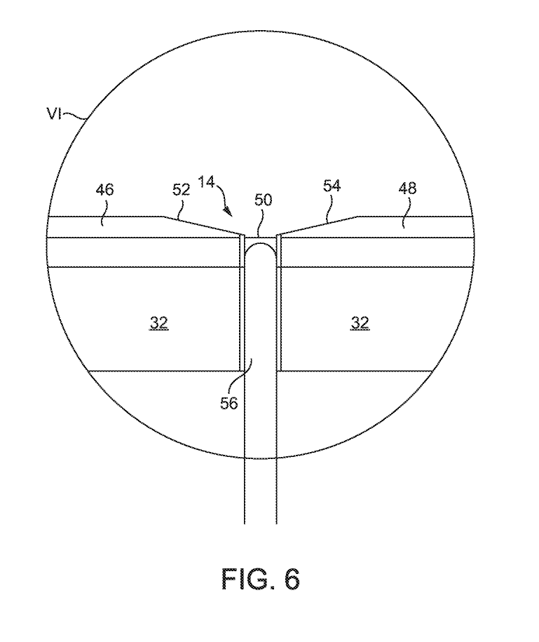

The construction of the bracket in the region of the living hinges can be appreciated from the detail provided by FIGS. 5 and 6. Since the construction of these regions of the bracket are identical for the hinges 12 and 14, only the region around the hinge 14 will be described.

The portion of the flange 1 in the region of the hinge 14 is stepped to provide two narrow to thinner portions 46 and 48 on opposite sides of a thin web 50 that provides flexibility to the hinge. The portions 46 and 48 are bevelled at regions 52 and 54 which are immediately adjacent to the web 50. The bevelled region 52 constitutes a first tapered portion, and the bevelled region 54 constitutes a second tapered portion. It will be appreciated that third and fourth tapered portions, identical to the first and second tapered portions 52 and 54, are provided immediately adjacent hinge 12. The wall 32 includes an axial, vertical gap 56 in the region of the web 50. The bevelled regions 52 and 54 and gap 56 enable the two halves 16 and 18 to hinge, about the web 50, so that the bevelled regions 52 and 54 move towards each other and the portions of the wall 32 on either side of the gap 56 are pivoted away from each other. This pivotal movement brings the two halves together with the surface of the flange 1 which is uppermost, (when the bracket has been installed) facing inwards and the lowermost surface of the flange 1 facing outwards. The tapered portions enable the two halves 16 and 18 to be folded further, so that they are closer together in the folded bracket, than otherwise would be the case.

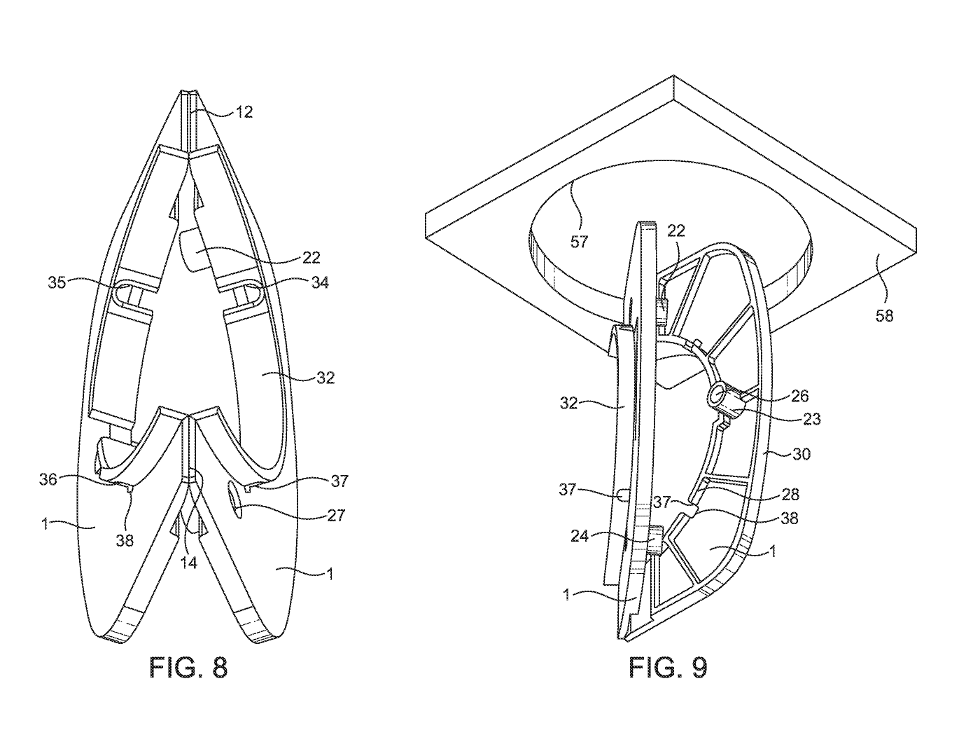

The folded condition of the bracket is shown in FIGS. 8 and 9. As can be seen from, in particular, FIG. 9, the bracket when in its folded condition can be inserted into an aperture (in this case hole 57) in a plasterboard ceiling panel 58, despite the fact that the radius of the hole is very close to the radius of the outer periphery of the wall 32 (when the bracket is unfolded) and thus the fact that the flange 1 has a greater lateral extent than the hole 57 when the bracket is unfolded.

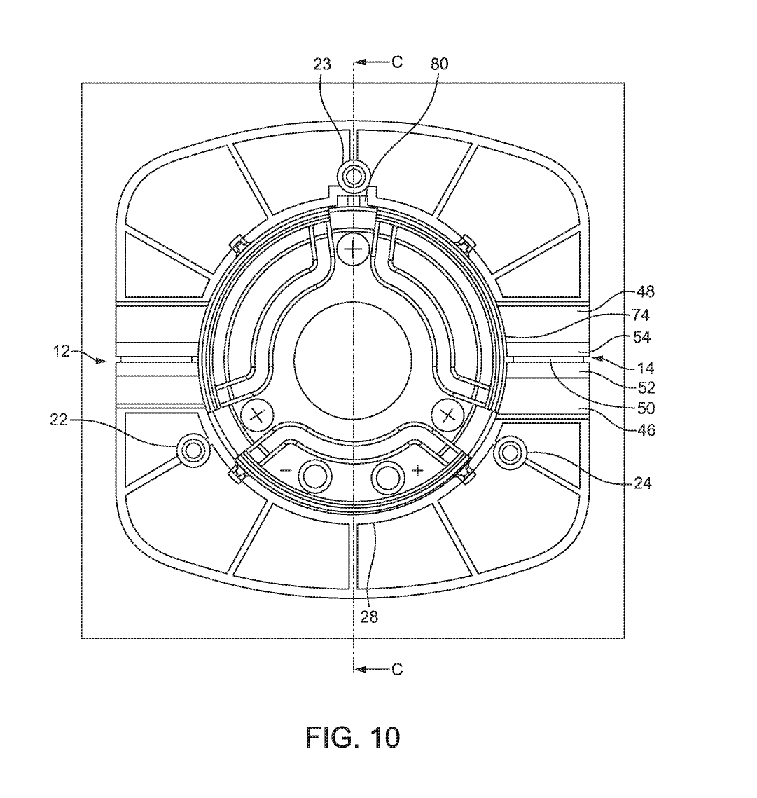

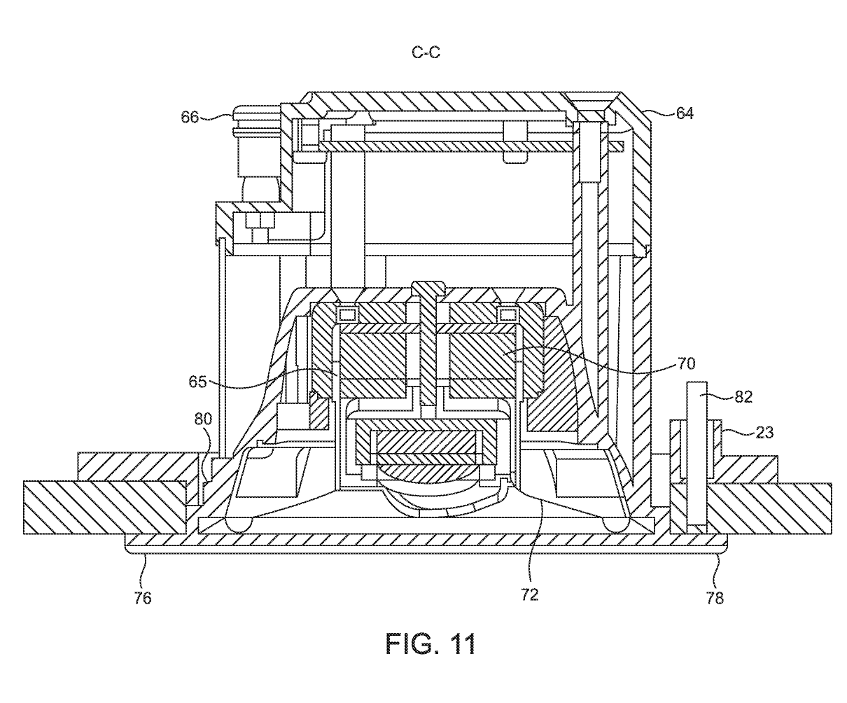

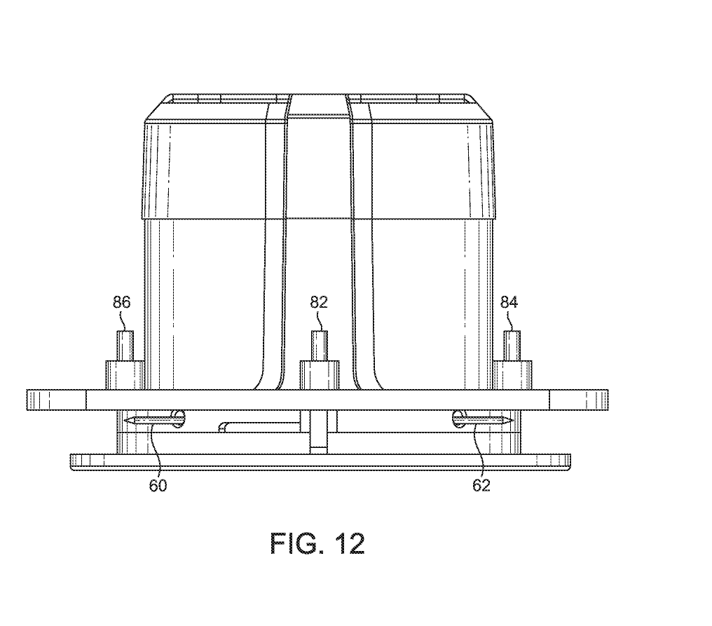

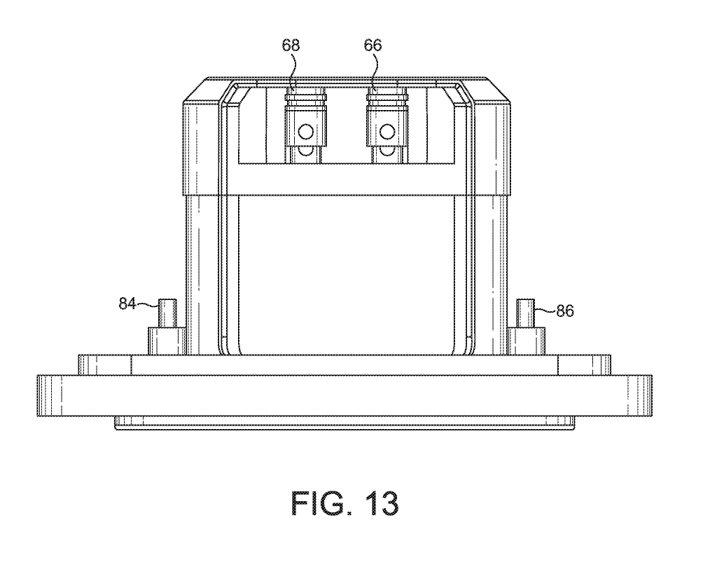

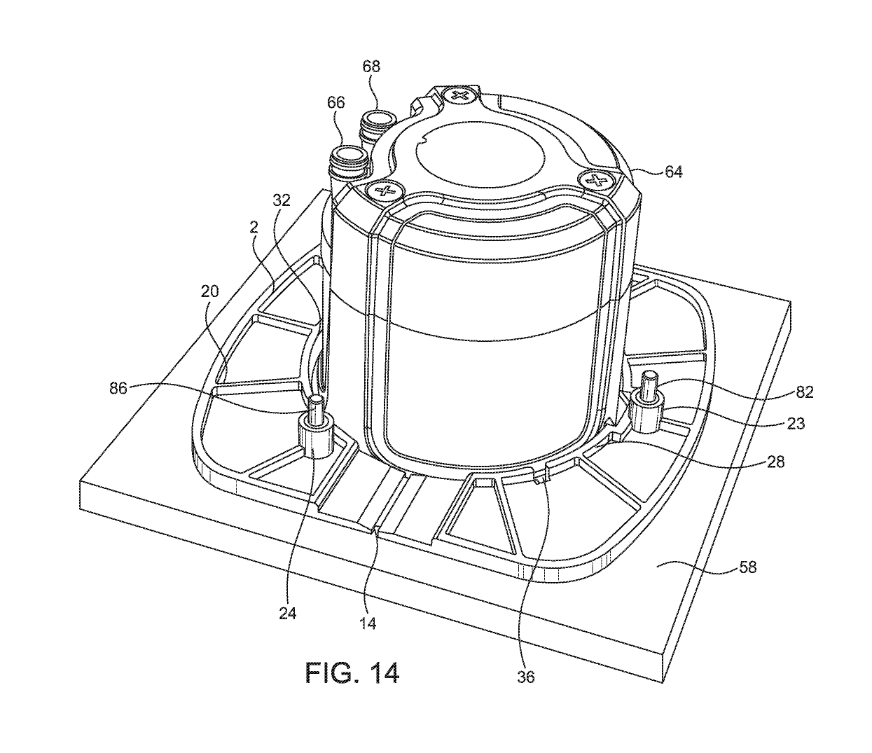

Once the bracket has been inserted through the hole, it is unfolded so that the underside of the flange 1 sits against the top face of the ceiling panel, whilst the wall 32 bears against the openings. A respective pin is then inserted through each of the openings 34-37 in the wall so that the pins extend radially out from the wall to penetrate the plasterboard at the gap 56. Two of these pins are shown at 60 and 62 in FIG. 12. The pins prevent the bracket from being lifted up away from the ceiling panel as a loudspeaker 64 (FIGS. 10-14) is inserted into the aperture 11. FIG. 11 shows the loudspeaker in section, and thus shows various of the speaker's components. The speaker is a moving coil loudspeaker in which a voice coil 65 connected to terminals 66 and 68 via which an electric current representing the audio signal to be reproduced is supplied to the coil. The coil operates with a magnet 70 to drive a diaphragm 72 to produce an audio output in response to the current fed to the coil. The internal components of the loudspeaker are conventional, and will therefore not be described in detail.

The speaker has a cylindrical housing 74, the lower end of which is provided with an out-turned flange 76 which is provided with three equi-angularly spaced counter-sunk screw holes, such as hole 78, which are at the same radial position as the passages 25-27 in the flange 1 of the bracket. A protuberance or pip 80 projects radially outwardly from the housing 74, and cooperates with the cutout 40 to achieve angular location of the loudspeaker relative to the bracket.

After the bracket has been installed and pinned in position, the loudspeaker is offered up to the aperture 11 with the protuberance 80 aligned with the cutout 40. If the protuberance 80 is aligned with the axial slot 44 the loudspeaker can be slid straight into position in the bracket. If however, the protuberance is aligned with the rail 42, the rail will prevent full insertion of the loudspeaker, but will allow the loudspeaker to be rotated in a clockwise direction when viewed from below until the protuberance 80 and slot 44 are aligned, so that the loudspeaker can then be slid into position.

With the loudspeaker so positioned, the holes in its flange 76 will be in alignment with the passages 25-27 so that the loudspeaker can be fixed to the bracket by passing screws (such as the screws 82, 84 and 86) through the holes in the flange 76, through the plasterboard and into the corresponding passages 25-27 in the flange 1. It will be appreciated that this not only attaches the loudspeaker to the bracket, but also clamps the loudspeaker and bracket assembly to the plasterboard panel.

1. A bracket for use in mounting an item in an aperture in a wall or a ceiling panel, wherein the bracket is foldable between a folded condition, in which it can be inserted into the aperture from one side and an open condition in which, in use, the bracket engages the panel so as to prevent removal of the bracket, the bracket, when in its open condition, having a receiving arrangement for receiving said item.

2. The bracket according to claim 1, in which the foldability of the bracket is achieved by means of at least one hinge in the bracket.

3. The bracket according to claim 2, in which the hinge is one of two such hinges which are substantially coaxial and are on opposite sides of the receiving arrangement.

4. The bracket according to claim 3, in which each hinge is a living hinge.

5. The bracket according to claim 3, in which the bracket has first and second tapered portions immediately adjacent, and on opposite sides of, one of the hinges, and third and fourth tapered portions immediately adjacent, and on opposite sides of, the other hinge, each of said tapered portions becoming progressively thinner with decreasing distance from the hinge.

6. The bracket according to claim 5, in which the tapered portions are bevelled.

7. The bracket according to claim 5, in which the bracket includes an abutment which, in use, engages a face of the panel opposite said one side of the panel, to enable the bracket to be secured to the panel.

8. The bracket according to claim 7, in which the abutment comprises a flange.

9. The bracket according to claim 8, in which the receiving arrangement comprises an opening in the bracket, when in its open condition, the opening being surrounded by the flange.

10. The bracket according to claim 9, in which the flange is an annular flange.

11. The bracket according to claim 9, in which the bracket includes an angular location arrangement for angularly locating the item relative to the bracket, the angular location arrangement comprising the opening in the bracket, the opening being of a non-circularly symmetric shape which corresponds to a correspondingly shaped portion of the item inserted into the opening, so as to prevent the item being inserted unless in a predetermined angular position relative to the bracket.

12. The bracket according to claim 11, in which the angular location arrangement comprises a male member or a female receptor on the receiving arrangement of the bracket which cooperates with a complementary formation on the item.

13. The bracket according to claim 8, in which the tapered portions are on the flange.

14. The bracket according to claim 8, in which the bracket includes a boss for extending from the flange into said aperture in the panel, to locate the bracket relative to the panel, the boss surrounding the aperture in the bracket, when the latter is in its open condition.

15. The bracket according to claim 14, in which the boss comprises a cylindrical wall.

16. The bracket according to claim 14, in which the flange extends radially outwardly from the boss, when the bracket is in its open condition.

17. The bracket according to claim 16, in which the flange of the bracket includes a plurality passages for fixing screws so that such screws, having passed through corresponding openings in the item, can pass through the panel and into the passages to clamp the panel between the bracket and the item, wherein the passages are lined with metal inserts.

18. The bracket according to claim 17, in which the bracket has three, and only three, such passages.

19. The bracket according to claim 14, in which the boss is surrounded by the flange, when the bracket is in its open condition.

20. The bracket according to claim 19, in which the boss is integrally formed with the flange.

21. The bracket according to claim 14, in which the boss includes formations from which, in use, locating elements may project into the portion of the panel that defines the aperture therein, to retain the bracket in position on the panel.

22. The bracket according to claim 21, in which the formations comprise U-shaped openings for accommodating locating elements in the form of pins, which, in the course of installing the bracket, are pushed through the U-shaped openings and into the panel.

23. The bracket according to claim 1, in which the bracket includes an angular location arrangement for angularly locating the item relative to the bracket.

24. The bracket according to claim 1, in which the bracket is for use in mounting an item comprising a loudspeaker.

25. A mounting bracket for mounting a loudspeaker in an aperture in a wall or a ceiling panel, the bracket comprising two halves which are hingedly joined together to enable the bracket to be opened from a collapsed condition, in which it can be passed through said aperture, into an open condition in which the bracket engages the panel.

26. The bracket in accordance with claim 25 in combination with the loudspeaker.

27. The combination according to claim 26, in which the loudspeaker has one of a protuberance and a female receptor which cooperates with the other of a protuberance and a female receptor in the bracket to ensure correct angular positioning of the loudspeaker relative to the bracket.
